(19) United States
(12) Patent Application Publication
(10) Pub. No.: US 2014/0095509 A1
(43) Pub. Date: Apr. 3, 2014

(54) METHOD OF TAGGING CONTENT LACKING GEOTAGS WITH A LOCATION

(71) Applicant: Banjo, Inc., Redwood City, CA (US)

(72) Inventor: Damien Michael Patton, Redwood City, CA (US)

(73) Assignee: Banjo, Inc., Redwood City, CA (US)

(21) Appl. No.: 14/043,479

(22) Filed: Oct. 1, 2013

Related U.S. Application Data
(60) Provisional application No. 61/709,103, filed on Oct. 2, 2012.
(60) Provisional application No. 61/782,687, filed on Mar. 14, 2013.
(60) Provisional application No. 61/784,809, filed on Mar. 14, 2013.

(51) Int. Cl. G06F 17/30

(52) U.S. Cl. CPC G06F 17/30241
USPC 707/740; 707/736

(57) ABSTRACT

A method including: at a system, determining a set of user accounts associated with a first user for each of a set of social networking services, an event timeframe for an event, and an event location for the event; receiving, at the system, a set of digital content generated by the set of user accounts during the event timeframe; in response to detection of a first digital content lacking a geographic location information within the digital content set, associating the event location with the first digital content; and in response to receipt of a query comprising an identifier for the event from a device, sending the first digital content to the device.

### CROSS-REFERENCE TO RELATED APPLICATIONS

This application claims the benefit of U.S. Provisional Application Nos. 61/709,103 filed Oct. 2, 2012, 61/782,687 filed Mar. 14, 2013, and 61/784,809 filed Mar. 14, 2013, which are incorporated in their entirety by this reference.

### TECHNICAL FIELD

This invention relates generally to the social networking services field, and more specifically to a new and useful method of identifying content generated at an event location in the social networking services field.

### BACKGROUND

It is oftentimes desirable for a user to view content generated by users attending a given event, particularly when the user is remote from said event. However, while attending users tend to generate and post a vast quantity of content about the event to various social networking systems, many of these users do not geotag this content. Subsequently, this extremely relevant content does not appear on location-based searches. Conversely, many users that are not attending the event also generate content about the event, but this content can be less relevant to other users that are interested in the on goings of the event. Unfortunately, this less relevant content shows up when a keyword-based search is performed. Thus, there is a need in the social networking services field to create a new and useful method of tagging content previously lacking geotags with a location to enable more relevant location-based searches.

### BRIEF DESCRIPTION OF THE FIGURES

FIG. 1 is a schematic representation of a variation of the method.

FIG. 2 is a schematic representation of a variation of determining user attendance at an event.

FIG. 3 is a schematic representation of a variation of determining user attendance at an event and tagging content lacking geotags that are generated by user accounts associated with the user with the event location.

FIG. 4 is a schematic representation of adjusting the event location based on changes in geographic content density.

FIG. 5 is a schematic representation of adjusting the event location based on time.

FIG. 6 is a schematic representation of a variation of monitoring content generated by a first user, associating an event location with the identified content, and sending content associated with the event location to a user device in response to receipt of an event query.

FIG. 7 is a schematic representation of a variation of monitoring content generated by a first user, associating an event location with the identified content, adjusting the event location based on the location information associated with the identified content, and sending content associated with the event location to a user device in response to receipt of an event query.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

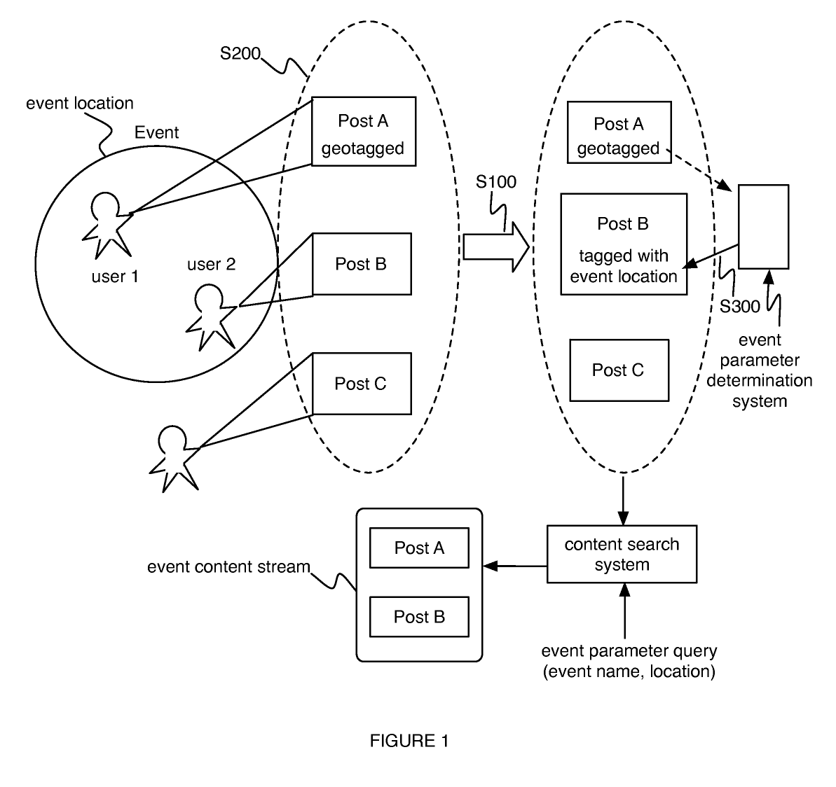

As shown in FIG. 1, the method of associating content lacking geotags with a location includes determining event parameters including an event timeframe and an event location S100, identifying digital content associated with the event S200, and tagging content with the event location S300. This method functions to differentiate content generated at the event from content that simply references the event (e.g., through a hashtag or keyword). To do so, this method identifies content generated by users physically located at the event.

While an event can be a planned public or social occasion, an event can also be any suitable intersection of a physical location and a timeframe. For example, an event can be a “work” event that is associated with a known work location of the user during known working hours for the user. Posts generated by the user during work hours can be tagged with the work location. In another example, an event can be a “vacation” event that is associated with a vacation timeframe and a vacation location. In another example, a substantially spontaneous event, such as a car accident, can be dynamically created and associated with an accident timeframe (e.g., extending from the timestamp of the first digital content until an end condition is met) and an accident location (e.g., the location associated with the most common geotag of the relevant digital content).

The method is preferably used to identify content generated at an event, more preferably at the event location, even though the content is not specifically geotagged with the event location. This method is preferably utilized with a primary method, such as that disclosed in U.S. application Ser. No. 13/491,363 filed Jun. 7, 2012 incorporated herein in its entirety by this reference but alternatively any other suitable method, that receives a geographical location query (e.g., of a physical location), accesses or retrieves digital content from a set of online social networking systems, and returns the content tagged (e.g., associated through metadata) with the location or a related location (e.g., within a predetermined radius or boundary associated with the location). Alternatively, the primary method receives an event query from a user device S400, determines a geographic location associated with the event (the event location), accesses or retrieves digital content related to the event location from the set of online social networking systems S200, and sends the digital content having location data associated with the event location to the user device S500. In use, the primary method functions to return (e.g., present) content generated by users within said physical geographical location. The returned content is presented in a content feed or list on the user device. The content feed is preferably time-ordered, but can alternatively be ordered according to individual popularity of the post, the influence of the content author, or ordered in any other suitable manner. The digital content is preferably filtered for specific types of content (e.g., filtered to select content including images and/or video) before or after content retrieval from the social networking systems, but can alternatively be unfiltered. In one example, the primary method can receive a physical location of a first user (user location) as the location query and return content generated by the user's connections on one or more online social networking systems within a predetermined distance of the user location. In a second example, the primary method can receive a physical location input (e.g., user entry) as the location query and return public and/or private content tagged with a location associated with the queried location. In a third example, the primary method can receive an event name input (e.g., user entry or selection) and return public and/or private content having location metadata associated with the event location.

The primary method is preferably performed by an aggregation system, but can alternatively be performed by any other suitable system. The aggregation system is preferably separate from and external to the social networking systems (e.g., hosted on a different domain, owned by a separate entity, accessible through different permissions, etc.), but can alternatively be a portion of a social networking system. The instantaneous method and the primary method are preferably performed by the same system, but can be performed by different systems.

The aggregation system preferably associates the different user accounts belonging to a given user together. The aggregation system can additionally access and/or retrieve the digital content generated by the different user accounts of the user. The aggregation system can additionally remove redundant digital content from the set of retrieved digital content (e.g., the same digital content posted on two different social networking systems). The aggregation system can additionally access the social networks through the different user accounts to access private information.

### 1. Determining Event Parameters.

Determining event parameters S100 functions to determine the event timeframe and the event location, such that digital content that is associated with the event and generated within the event timeframe can be associated with the event location. Determining the event parameters can additionally include determining the event name, determining the anticipated event attendees (e.g., users), or determining any other suitable event parameter.

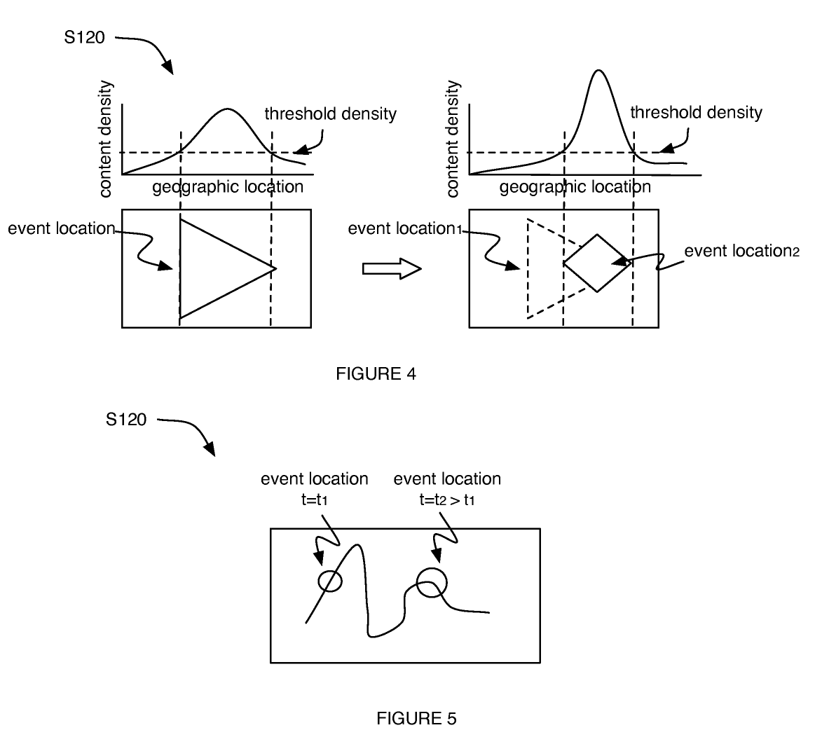

The event preferably includes an event name (e.g., the name of a festival). The event can additionally or alternatively be identified by an event identifier, such as a URL, link, hashtag, image, or any other suitable identifier. The event is preferably an event located at a physical location (event location), wherein the physical location is preferably universal, but can alternatively be personal and unique to the user (e.g., the geographic location of the user's home or workplace). The event location is preferably a physical geographic location, but can alternatively be any suitable location. The event location is preferably a physical area (e.g., geographic region) bounded by a boundary, but can alternatively be a point, a radius about a point, or defined in any other suitable manner. The boundary is preferably determined by physical boundaries (e.g., by building walls, geographic features, etc.), but can alternatively be determined by political boundaries (e.g., country, state, county, etc.), determined by a user (e.g., entering a radius value, drawing a boundary, etc.), determined by the associated locations of event-related content (e.g., wherein the boundary is determined by the points where the geographic density of associated content falls below a threshold density, as shown in FIG. 4), or determined in any other suitable manner. The physical location can have any suitable amount of resolution and be any suitable geographical tier, level, or classification (e.g., country, state, city, building, room, etc.). The event location is preferably defined by a physical area bounded by a boundary (e.g., a geometric or polygonal boundary), but can alternatively be identified by a radius extending from a set of geographic coordinates (e.g., a set of latitude and longitude coordinates), GPS coordinates, altitude measurements, text, or any other suitable physical location identifier.

The event is preferably associated with an event time or timeframe (e.g., event time period), which is preferably a temporal duration bounded by a first and a second time. The first and second time are preferably identified by a first and second timestamp, respectively, but can alternatively be defined by a first and second time duration from a reference time, or defined in any other suitable manner.

In a first variation of the method, the event location and event timeframe are preferably predetermined (e.g., automatically determined) and stored in association within an event database, such as a schedule. The event database can additionally or alternatively include the event name or identifier, a list of users intending to attend the event, or a list of the user account identifiers associated with the users attending the event.

In a second variation of the method, the event identifier (e.g., event name, keywords, etc.), event location, event time, and/or set of event-associated user accounts can be received by the aggregation system from a user device. The user device is preferably a portable device (e.g., a smartphone, a tablet, a laptop, gaming system, a wearable device such as an Internet-connected watch or token, etc.), but can alternatively be a desktop device (e.g., a television, computer, etc.).

In a third variation of the method, the event location can be dynamically determined (e.g., automatically determined in near real-time by the system). A location can be identified and set as the event location in response to a volume or frequency of posts, generated by a set of unique users and having content parameters indicative of a location within a common geographic location, exceeding a volume or frequency threshold within a threshold time period. The common geographic location can be extracted from one of the posts having content parameters referencing the geographic location. The geographic location or a related location (e.g., an obfuscated or otherwise processed location) is preferably stored (e.g., set) as the event location. The threshold volume or frequency of posts and/or threshold number of unique users can be predetermined or dynamically determined. The threshold time period can be predetermined or dynamically selected based on event type (e.g., event categorization). The event type can be determined from common user interest amongst the post authors, common post content (e.g., keywords within text content, hashtags, tags, image subjects, sounds, etc.), from a schedule, or from any other suitable source. For example, an event can be considered as active and on-going when a hundred different users post content geotagged with AT&T park within a 20-minute period.

In an alternative of the third variation, a geographic location is identified and set as the event location in response to a volume or frequency of posts, generated by a single user and having content parameters indicative of locations within a common geographic location, exceeding a volume or frequency threshold within the predetermined time period. The common geographic location can be extracted or otherwise determined from one of the posts having content parameters referencing the geographic location. The user is preferably an influencer (e.g., a user whose content propagates through one or more social networks faster than a predetermined rate), but can alternatively be any other suitable user.

Determining the event location can additionally include adjusting the event location S120. Adjusting the event location can include increasing the event location resolution, adjusting the event location boundaries, moving the event location as a function of time, or adjusting the event location in any other suitable manner.

Increasing the event location resolution functions to increase the specificity of the geographic location used to tag the digital content. Increasing the event location resolution preferably does not affect the query limitations for digital content monitoring (i.e., identification). For example, increasing the event location resolution from San Francisco to Golden Gate Park does not change which digital content is identified (e.g., all the content having content parameters indicative of a location within San Francisco is still identified). Rather, increasing the event location resolution from San Francisco to Golden Gate Park results in content determined to be authored (generated) within Golden Gate Park to be tagged with Golden Gate Park. The event location resolution is preferably set to the location resolution that includes content having geotags referencing a location within the proposed area above a predetermined density or percentage threshold. For example, the location resolution can be set to Golden Gate Park when the geographic area defined by Golden Gate Park encompasses a majority of the content that is relevant to the event, as determined from the content geotags.

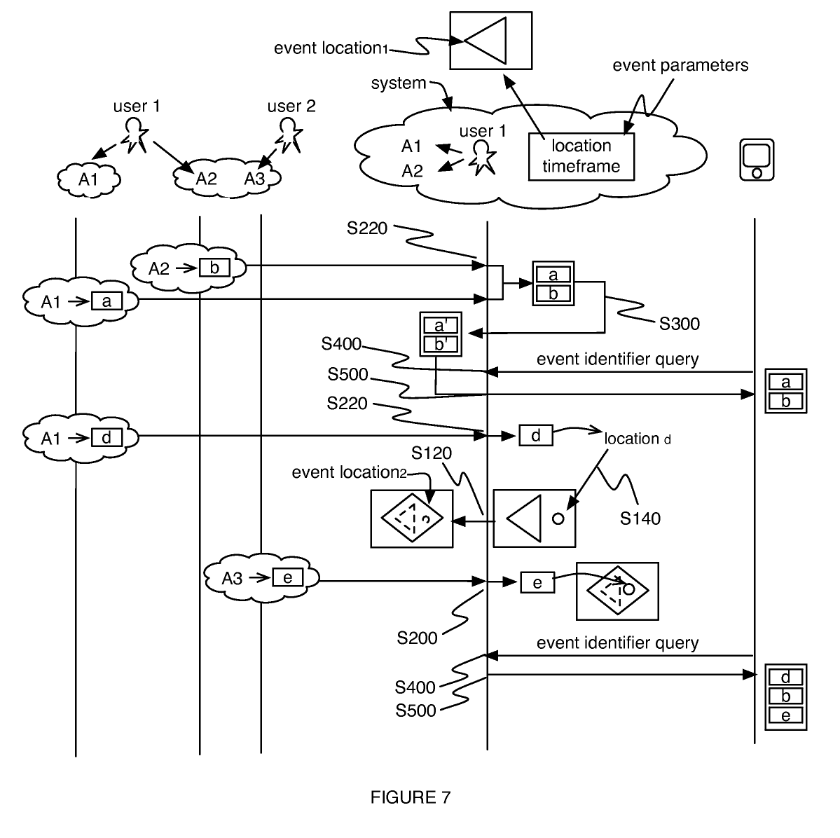

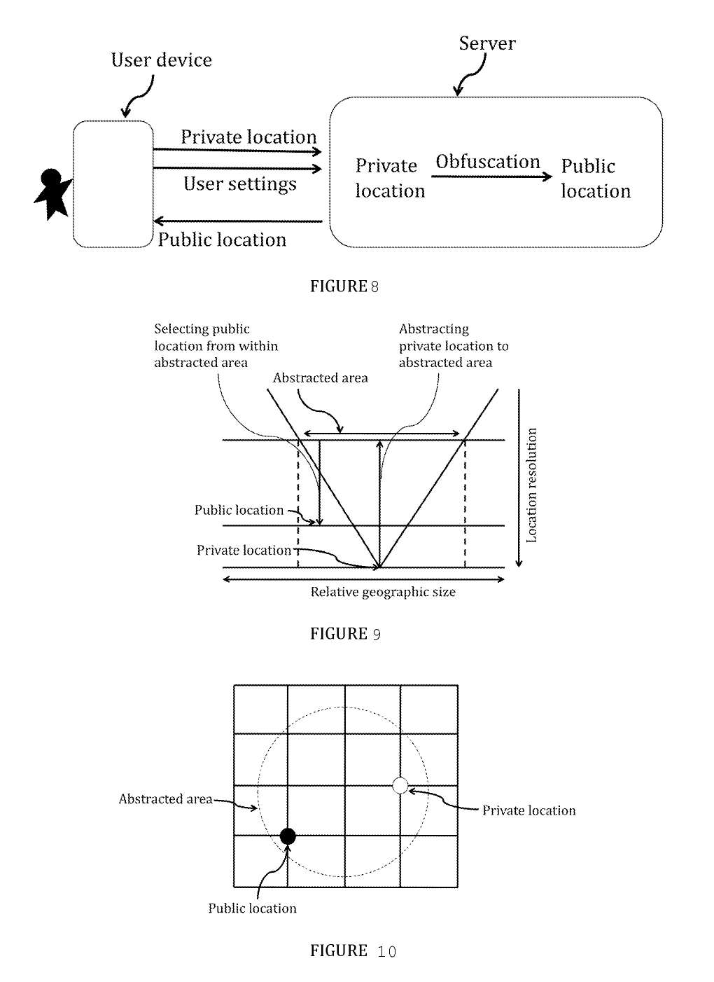

Adjusting the event location boundaries functions to refine the content identified from the content sources. Adjusting the event location boundaries can include adjusting the boundaries to increase the event location area, can include adjusting the boundaries to decrease to the event location area, or can include adjusting the boundary locations while substantially maintaining the event location area. The digital content identified after boundary adjustment preferably include content tagged with locations within the new boundaries, and exclude content tagged with locations external the new boundaries. Adjusting the event location boundaries can include extracting location information from digital content generated by a first user S140, and in response to the extracted location information indicating (referencing) a geographic location outside of the event location boundaries, adjusting the event location boundaries to include the indicated location, as shown in FIG. 7. Adjusting the event location boundaries can additionally include adjusting the boundary to exclude geographic locations having event-related content density lower than a density threshold. The boundary can be adjusted according to one or more rules, such as wherein the boundaries must trace a physical obstruction.

Automatically moving the event location as a function of time functions to automatically accommodate for relevant content migration across a physical space as a function of event progression. The path of event location movement is preferably predetermined (e.g., received from a user, learned from past similar events, etc.), but can alternatively be dynamically determined, as discussed above. In one example, the event location for which content is identified moves along a marathon route at a predetermined rate (e.g., the anticipated speed of the fastest runner) for a marathon, as shown in FIG. 5. In another example, the event location for which content is identified moves from a streetside location, along the length of the red carpet, and into an awards hall for an awards ceremony.

The method can alternatively include any combination of the aforementioned variations of adjusting the event location, or utilize any other suitable manner of determining the event location.

Determining the event location can additionally include obfuscating the geographic location derived from (e.g., extracted from) the digital content prior to setting the geographic location as the new event location. In one variation of the method, obfuscating the event location includes selecting an obfuscation tier encapsulating a broader physical area than the geographic location, generalizing the extracted geographic location to the respective geographic identifier of the obfuscation tier, and selecting a second geographic location within the obfuscated location. The second geographic location is preferably of the same categorical level as the extracted geographic location, but can alternatively be more or less specific. Selecting the second geographic location preferably includes pseudo-randomly selecting the second geographic location from the locations encompassed within the obfuscated location. Selecting the second geographic location can include selecting an obfuscation level (e.g., for the second geographic location) based on the event category. For example, when an event is categorized as a riot, the second geographic location can have an obfuscation tier on a city-wide level. In another example, when an event is categorized as an awards ceremony or race, the second geographic location can have a high-resolution obfuscation tier (e.g., within 100 ft of a given latitude and longitude). However, the second geographic location be selected in any other suitable manner.

In another variation of the method, the event timeframe can be dynamically determined. The event timeframe can be a predetermined time duration extending from a start timestamp. The start timestamp can be the timestamp of the first event-related post, the timestamp at which the post generation frequency exceeded the frequency threshold, or from the time that any other suitable event-creation condition was met. Alternatively, the event timeframe can be on-going or extended past the predetermined time duration while the volume of posts, generated by the set of unique users and having geotags indicative of a common geographic location, exceeds a second volume or frequency threshold. The second volume or frequency threshold can be the same as the first volume or frequency threshold, higher, or lower. Alternatively, the event timeframe can be extended past the end timestamp (e.g., beyond the predetermined timeframe) in response to a determination that a user (e.g., user-associated account) is generating content associated with the event at a time after the end timestamp. The user is preferably an influencer, but can alternatively be any other suitable user. The content is preferably associated with the event through a content-associated geotag indicating a physical location related to the event location, but can be associated through images, audio, or through any other suitable content parameter. The content generation time is preferably determined from the timestamp associated with the content. The content generation time is preferably within a predetermined time period after the end timestamp, wherein the predetermined time period can be a universal time period, selected based on the event category, selected based on the amount of time that the instance of the event has been on-going (e.g., 10% of the event timeframe), or selected in any other suitable manner.

The event name can be extracted from the content of the posts, such as from hashtags, user account references, or any other suitable content within each post. For example, the event can be considered a SF Giants® versus Oakland A's® game if the keyword “giants” and “A's” (or other permutations thereof) occur at a frequency beyond a threshold frequency within the posted content. The threshold frequency is preferably predetermined, but can alternatively be dynamically determined (e.g., the threshold frequency can be lowered if a highly influential person associated with the field of the event posts about the event).

2. Identifying Digital Content Associated with the Event.

Identifying digital content associated with the event 5200 functions to identify digital content to be associated with a geographic location. The digital content is preferably associated with the event through the author of the digital content and the time of digital content generation (e.g., limited to digital content from select user accounts generated within a select timeframe), but can alternatively be associated with the event through the location information associated with the digital content (e.g., limited to digital content having content parameters referencing a physical location within the event location), or through any other suitable content parameter. The identified digital content can include associated location information, or can lack associated location information. Content identification is preferably automatic and performed by the system, but can be alternatively identified (e.g., by a user, etc.)

Identifying digital content preferably includes receiving (e.g., in response to a retrieval request) digital content from a content source at the system of the method (e.g., aggregation system), wherein the digital content is associated with a geographic location by the system. Identifying digital content can alternatively include identifying the digital content on the content source, wherein the digital content is associated with the geographic location on the content source by the system through an API or other interface of the content source. For example, a post on Facebook® can be geotagged by the system through the Facebook API.

The content source is preferably one or more online social networking systems. Alternatively, the content source can include news sources, bogs, or any other suitable content source. Each social networking service is preferably an online service, platform, or site that preferably includes a plurality of user accounts, wherein each user account is preferably associated with a unique user. Examples of social networking systems include Facebook, Twitter, Linkedin, a digital group formed from linked email addresses, or any other suitable digital networking system. A given user can have a different user account for each of the set of social networking systems. The method is preferably capable of accessing and aggregating content from one or more user accounts of the user.

Each unique user can be associated with a user account on one or more social networking services. The method preferably aggregates the content associated with the multiple user accounts that are associated with a user. The user preferably indicates the user account associated with the user (e.g., usernames) for each of the social networking services to which the user belongs on the aggregation system, such as by entering and/or signing into each social networking service through the aggregation system (e.g., native application or browser application) that performs the method. However, user accounts that are associated with the user across multiple social networking services can be otherwise determined.

The digital content (i.e., electronic messages, posts, content, persistent content, persistent data, persistent posts, etc.) can include URLs, links, references, text, images, video clips, audio clips, and/or any other suitable content. The digital content can additionally include metadata (i.e., an associated set of data properties). The metadata can include a timestamp, a location (e.g., geotag, GPS coordinates, name of geographic location, etc.), a measure of location precision (e.g., radius of uncertainty), a categorization or identifier for the mobile device generating the content, the user account identifier, the content capture mechanism (e.g., front camera or back camera), or any other suitable parameter. The metadata is preferably representative of the respective parameters at the time of digital content creation or at the time the digital content was sent to the social networking system. The metadata is preferably associated with the digital content at the time of digital content generation (e.g., when the digital content is sent to the social networking system), but can alternatively be associated with the digital content after social networking system receipt. While the digital content preferably includes information for all available parameters, the digital content can alternatively lack information for some parameters, such as location information. The digital content can lack the parameter information due to a user preference restriction, due to the settings of the social networking system (e.g., wherein the social networking system does not associate location information with digital content), or for any other suitable reason.

Alternatively, the digital content can be associated with a time, location, or any other suitable parameter from the contents of the electronic message. For example, the digital content can include a textual reference to an event (e.g., through an event name, URL, or other suitable event identifier or reference), wherein the digital content can be associated with a known event time and event location associated with the event. In another example, an image can be processed to extract location or time-related metadata (e.g., exchangeable image file format data), extract a location from the image content (e.g., by image matching with a database), extract a location tag, or extract any other suitable information. In another example, the digital content can include text that references a location (e.g., a location name) and/or a time (e.g., a date, a time, a duration from the time of content generation, etc.), wherein the referenced location and/or time are the associated location and/or time. In another example, the digital content can reference a secondary source (e.g., a secondary user account), wherein digital content authored by the secondary user account includes a location and/or a time. The location and/or time associated with the primary digital content can be the referenced location and/or time found in the digital content authored by the secondary user account.

The digital content is preferably generated by a user using a social networking system through the respective user account. The social networking system preferably stores the generated digital content, but can alternatively facilitate persistent or temporary digital content storage on an external storage system. The digital content generated by the user account is preferably arranged on a user page or content feed (i.e., content stream) of the user account on the respective social networking system. The content stream can include user-generated content (e.g., content posted by the user account to the social networking service). The content stream for a user account can additionally or alternatively include content posted by secondary user accounts to the social networking system. The secondary user accounts can be user accounts that are followed, friended, or otherwise directly connected to the user account. The content stream is preferably a time-ordered list (e.g., ordered according to the time of generation), more preferably inversely time-ordered with the most recent content at the top of the list, but can alternatively be ordered according to popularity (e.g., as determined from the number of views of the content, number of actions on the content, etc.), or ordered according to any other suitable parameter.

Identifying digital content associated with the event can include identifying digital content associated with the event and filtering the set of identified digital content for content geotagged with a location associated with (e.g., located within) the event location, such as that shown in FIG. 1. The digital content can be associated with the event by including a keyword associated with or referencing the event, including a link to the event, be geotagged with the event location, generated within the event timeframe, or otherwise associated with the event.

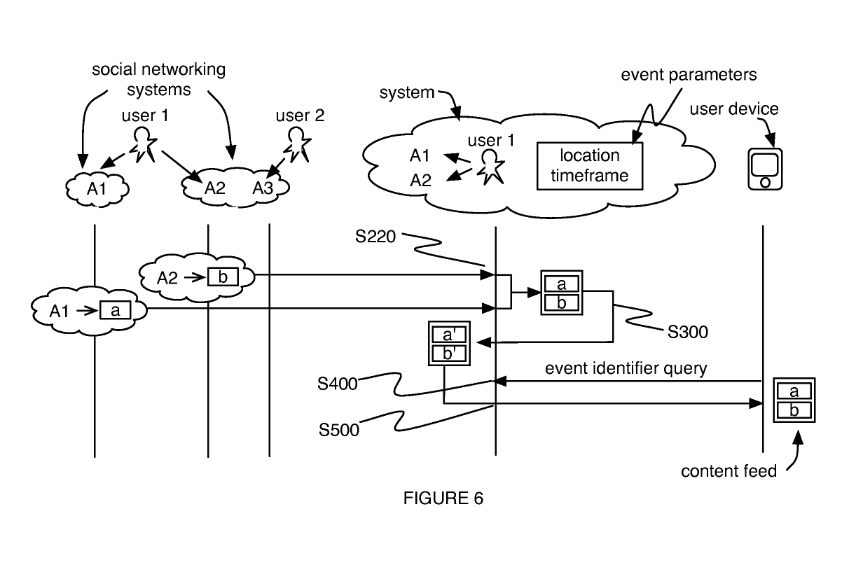

Identifying digital content can additionally or alternatively include identifying digital content authored (e.g., generated, posted, etc.) by a user of interest (i.e., primary user) S220, as shown in FIGS. 6 and 7. The user of interest is preferably categorized as an influencer, but can alternatively be any other suitable user. The user of interest can be categorized as an influencer due to one or more of the user-associated accounts having a virality score (e.g., content propagation rate) beyond a predetermined threshold, but can alternatively be categorized by a second user, a secondary source, or identified in any other suitable manner. The user of interest can be associated with a different user account for each of a set of social networking systems, wherein all or a subset of the associated user accounts can be monitored for new digital content. The associated accounts can be monitored during a predetermined event timeframe, constantly monitored, or monitored at any other suitable frequency.

Identifying digital content authored by a user of interest can additionally include determining user attendance at the event. Determining user attendance at an event functions to indicate that a user has a high likelihood of being at the event location during an event time period, and that content generated by the user during that time should be associated with the event location. The user attendance at the event can be determined in advance (e.g., the user will attend the event in the future, at a time after the time at which the user attendance is determined), or can be determined when the user is concurrently attending the event. Alternatively, user attendance can be determined after the event has occurred. Determining user attendance preferably additionally includes identifying the user accounts associated with the user, such that content generated by said accounts during the event time period can be tagged with the event location.

In one variation of the method, determining that a user will be or was at an event includes extracting the name of the user from an attendees list associated with the event. The attendees list can be stored within a database (e.g., a server), accessible online, or determined in any other suitable manner. Extracting the name of the user from an event list can include extracting the name of the user from a guest list (preferably public but alternatively private), extracting the name of a keynote speaker, extracting the name of the user from the team roster of a team assigned to play at the event, or extracting the name of the user from any other suitable list of anticipated attendees.

In another variation of the method, determining that a user will be or was at an event includes determining influencers that are anticipated or recorded to be at the event, wherein the event is preferably associated with the field of expertise or field of influence associated with the influencer. An influencer is preferably a user that has a broad reach (e.g., a number of followers and/or reposts above a threshold value) within a group of users interested in the influencer's field of influence. For example, George Clooney can be considered an influencer in the motion picture field, and can be anticipated to go to major motion picture awards events. Users that historically attend a recurring event (e.g., as determined from historical attendance) are preferably determined to attend the next instantiation of the recurring event.

In another variation of the method, determining a user is currently at, will be, or was at an event includes pre-associating the user with a given event location, which functions to semi-permanently associate the user with the event location. The user is preferably pre-associated with the event location for a predetermined set of times, but can alternatively be associated with the event location when a second user is determined to be located at the event location (e.g., through content analysis or location services through the second device) or associated with the event location dependent upon the user's history of event locations. For example, a SF Giants baseball player is preferably associated with AT&T Park for all home games. In another example, a SF Giants baseball player (and his associated content) is associated with AT&T Park any time a second SF Giants baseball player is determined to be at AT&T Park. In another example, the SF Giants baseball player is associated with AT&T Park for a game day when the history of the baseball player indicates that he was not at AT&T Park (e.g., at an away game) the two game days prior.

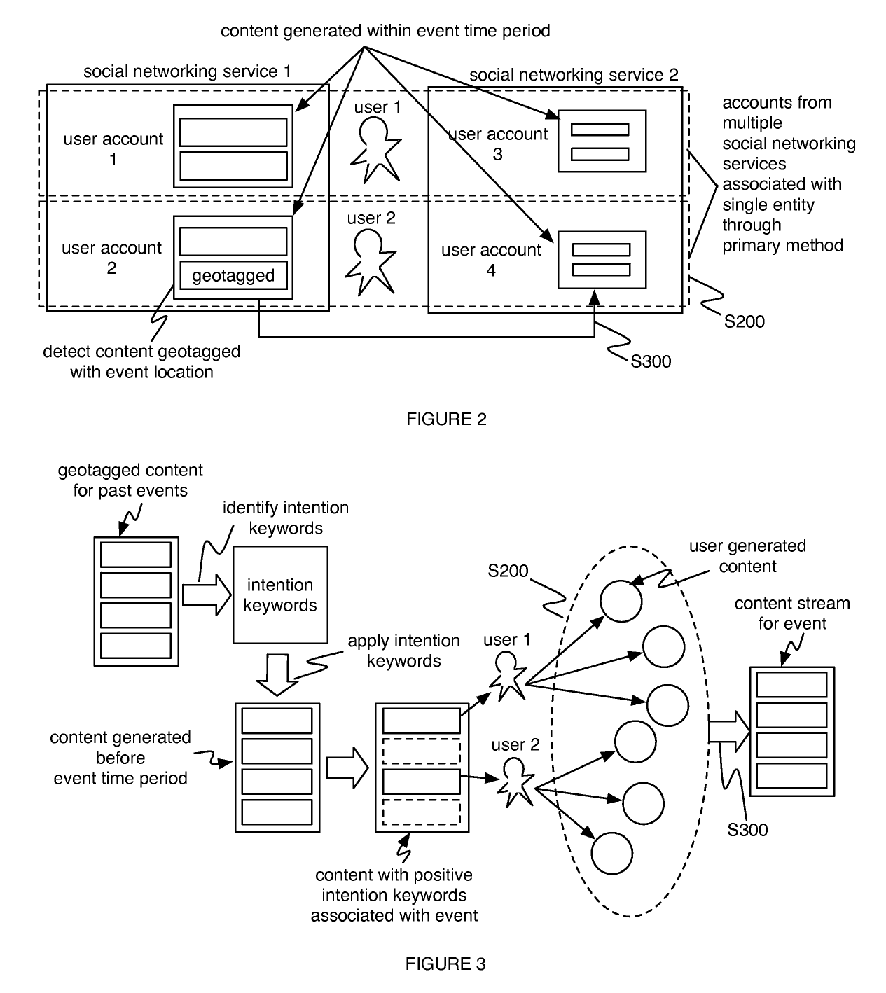

In another variation of the method (as shown in FIG. 2), determining that a user is currently at an event includes identifying a post generated by a user account associated with the user, wherein the content is geotagged with a location associated with the event location and is tagged with a time associated with the event time period. Content generated by user accounts associated with the user (e.g., on other social networking system services) within the event time period is preferably subsequently tagged with the event location.

In another variation of the method, determining user attendance at an event includes analyzing the content generated by the user's user accounts for intention indicators, as shown in FIG. 3. Intention indicators are preferably keywords, key phrases, sequences, non-consecutive series of keywords, grammar structures, or any other suitable linguistic construct indicative of a user intent to perform an action. More preferably, intention indicators are positive intention indicators indicative of a user intent to go to an event. Examples of intention indicators include “at,” “going to,” or “can't wait to go to.” This variation allows the method to differentiate between users that will physically attend the event and users that are simply posting about the event, thereby allowing the method to differentiate between content generated at the event and content that simply references the event. Discovery of a positive intention keyword within the content posted by a user account associated with the user prior to the event time period or during the event time period preferably results in all content generated during the event time period by the user accounts of the user being tagged with the event location. More preferably, determination of a positive intention keyword linked with a keyword indicative of a location (e.g., “home”) within the posted content preferably results in the post and all subsequent posts within a predetermined time period to be tagged with the indicated location. Alternatively, the content can be analyzed for negative intention indicators, wherein negative intention indicators indicate that the user will not be attending the event. Examples of negative intention indicators can include “not going to,” or “not at.” This can be particularly desirable when negative intention indicators are detected within the content of a user account that was previously determined to be attending the event. When such an instance occurs, the content generated by user accounts associated with said user is preferably not tagged with the event location. Intention indicators are preferably determined through machine learning algorithms that are trained on sets of geotagged content, wherein the identified intention indicators are preferably the keywords or key phrases that are highly correlated with the user generating the event-associated content being located at the event location. During the machine learning training, the event location is preferably known, but can alternatively be unknown. Using machine learning to determine intention indicators permits the method to determine intention indicators without in-depth knowledge of the language in which the content is posted. However, the intention indicators can be keywords drawn from a predetermined list of keywords, or determined in any other suitable manner.

In another variation of the method, determining that the user is currently located at the event includes matching the content of non-text posts generated by the user (e.g., images, videos, or audio clips) to images, videos, or audio clips that are known to be associated with the event (e.g., as posted by another user, wherein the posted content is tagged with a geotag). Once the image, video, or audio clip of the first post lacking a geotag is matched to an image, video, or audio clip of the second post having a geotag, all content generated by user accounts associated with the user that generated the first post during the event time period is preferably subsequently tagged with the event location.

In another variation of the method, determining user attendance at an event includes tracking content, posted by secondary user accounts (e.g. user accounts associated with other users) on which the user is taking action. User actions are preferably content generated by the user that relies upon a second piece of content. User actions can include reposting, commenting on, referencing, or any other suitable action. When a positive intention indicator (e.g., “I was there too!”) is detected within user actions on a piece of content geotagged with an event location, the content generated by the user during the associated event duration is preferably tagged with the event location as well. Alternatively, when multiple user actions are performed by a singular user on multiple pieces of content that are each associated with substantially similar locations (e.g., as determined through geotags, tagged locations, etc.), the content generated by the user during the event duration is preferably tagged with the common location. The event duration can be a previously determined event duration (e.g., from a schedule), be the period of time extending from the first user action on said content to the time of location-associated content generation cessation, be the period of time extending from the generation of the first location-associated content to the time of location-associated content generation cessation, or be any other suitable event duration.

In another variation of the method, determining user attendance at an event includes determining secondary content generated by secondary users that reference the primary user. The secondary content preferably includes content parameters indicating a location associated with (e.g. within) the event location and a timestamp associated with (e.g., within) the event timeframe. The secondary content preferably additionally includes content indicative of primary user presence at the event. Content indicative of primary user presence at the event can include keywords indicative of proximity (e.g., a user identifier, such as a name or user account reference, followed by “here,” “nearby,” or other similar words indicative of proximity), an image of the primary user, audio of the primary user, or any other suitable content from which the primary user identity can be determined.

In another variation of the method, determining user situation at an event location includes determining the substantially instantaneous user location from a background location service executed on the user device. For example, the system (e.g., the native application) can access location services (e.g., GPS, cell tower triangulation, etc.) and send the substantially instantaneous user location to the server of the system. In another example, the system (e.g., the native application) can access or request location data from a third party service, such as Google Latitude™, Foursquare™, or Find My Friend™

Identifying content can alternatively include identifying digital content associated with a location (e.g., as determined through associated geographic location information) or associated with a time within a timeframe (e.g., as determined through associated time information). The location or timeframe can be a location or time associated with a predetermined event, respectively. However, the location or common timeframe can be with a dynamically determined event.

In one variation of the method, when a user is anticipated or known to be at an event location during an event timeframe, all digital content generated by the accounts associated with the user during the event timeframe can be identified.

In another variation of the method, all content generated on a first social networking system can be continuously monitored, and digital content generated on a second social networking system can be monitored in response to the frequency of new digital content associated with a geographic location surpassing a frequency threshold. The monitored digital content on the second social networking system can include digital content associated with the event (e.g., associated with the geographic location and generated within a predetermined time duration from the time that the frequency threshold was surpassed). The monitored digital content on the second social networking system can additionally or alternatively include digital content authored by the user account of a user that authored digital content associated with the event on the first social networking system. The user can be the first user to author content on the first social networking system associated with the event, an influencer, the user that authored the highest referenced or viewed content, or any other suitable user.

In another variation of the method, the event location is identified from the content generated by a first user, wherein the event location is used to identify, from the set of social networking systems, content generated at the event location by secondary users. This variation of the method can include monitoring the user accounts on the set of social networking systems that are the first user. The first user can be an influencer, or can be any other suitable user. The event location is used to query the social networking systems in response to the content generated by the first user in association with the event beyond a predetermined frequency. The content generated by the first user can be within a single social networking system or across multiple social networking systems. The content can be associated with the event through the content timestamp, keywords, event references, geotagged content identifying a location known to be associated with the event, or otherwise associated with the event.

The method can alternatively include any combination of the aforementioned variations of determining user attendance at an event, or utilize any other suitable manner of determining user attendance at the event.

### 3. Tagging Content

Tagging content S300 functions to tag content that should have been tagged with the event location. Tagging the digital content with a geographic location can include identifying a first post (digital content) within the set of digital content identified in S200, and associating a geographic location with the first post. The content is preferably automatically tagged by the system, but can alternatively be otherwise tagged (e.g., by a user, etc.).

Identifying a first post from the set of digital content functions to identify a post that includes content relevant to the event but is not associated with appropriate location information. In one variation of the method, identifying the first post includes identifying a post that lacks an associated geographic location. The first post can have a default value (e.g., null value) as the associated location parameter or not have a location parameter option. The first post can additionally lack geographic location information within the content of the post, or be otherwise unassociated with a geographic location.

In another variation of the method, identifying the first post includes determining a disjunction between the respective location information associated with a first and second post, wherein the second post is also within set of identified digital content and has associated geographic location information. The location information of the second post is preferably more precise than the first post. The second post location information can be more precise than the first post location information when the second post location is indicative of a higher resolution geographic location (e.g., the second post location references a stadium whereas the first post location references a city), has a smaller uncertainty range, or is otherwise indicative of a smaller physical area then the first post location. The disjunction between the respective location information associated with the first and second posts can be determined when the first post lacks associated geographic location information and the second post is associated with geographic location information, when the second post has more precise geographic location information than the first post, when the first and second posts are indicative of different geographic locations (e.g., wherein the first and second posts are both associated with a given timestamp, wherein a majority of the posts associated with the timestamp are associated with a first geographic location, and wherein the first post is a post in the minority and the second post is a post in the majority) or when any other suitable discrepancy between the geographic location information of the first post and the geographic location information of the second post is determined.

Associating the geographic location with the digital content functions to assign, tag, or otherwise link the geographic location with the first post. The geographic location is the event location, determined as described above. Associating the geographic location with the digital content can include storing a reference to the geographic location (e.g., latitude and longitude coordinates) as the location parameter for the content (e.g., as the geographic metadata), inserting a reference to the geographic location into the body of the digital content (e.g., text, URL, link, hashtag, etc.), storing a reference to the event (e.g., event name, event identifier, etc.) as the event parameter for the content, inserting an event reference into the content (e.g., event name, event identifier, event URL, event-related hashtag, etc.), linking the content with the event (e.g., placing a unique content identifier, such as a URL, on a list of content associated with the event), or otherwise associating the event location with the content. The geographic location can be obfuscated prior to association with the digital content. In one example, when the digital content is previously associated with a first geographic location, the newly associated geographic location can be obfuscated to the same geographic resolution as the first geographic location. However, the geographic location can be obfuscated in any other suitable manner.

The digital content is preferably associated with the content by the service. The digital content and associated location are preferably stored by the service, such that the content is tagged with the geotag on the content stream or feed provided by the service, but can be untagged or have a different geotag on the content stream provided by the originating social networking system. Alternatively, the content can be tagged with the geotag within the originating content stream (e.g., within the originating social networking system service), wherein tagging the content includes sending the originating social networking system service a notification including an identifier for the post and a location identifier indicative of the event location, tagging the post with the event location through the social networking system API, or otherwise adjusting the content parameters for the post as stored on the social networking system.

The method can additionally include displaying the tagged content in response to receipt of a query for an event-associated parameter S500, as shown in FIG. 1 and FIG. 3. Event-associated parameters can include the name of the event, the location of the event, or any other suitable parameter of the event. In one example, upon the receipt of a query for “SXSW,” all content generated within Austin, Tex. within the time period for South by Southwest, as determined and tagged by the method, is displayed in an event content stream. Multiple instances of same post generated by different user accounts of the same user (e.g., same post content, as determined by keyword, image, video, or audio matching) are preferably reduced to a single instantiation, but can alternatively appear as multiple instances within the event content stream. The event content stream is preferably time-ordered, but can alternatively be ordered by popularity (e.g., as determined from the number of views, number of actions such as positive indicators or comments, etc.), or ordered in any suitable manner. The event content stream can additionally be displayed or brought to the attention of a user (e.g., through a notification or alert) in response to the satisfaction of a rarity condition. The rarity condition can be satisfied in response to determination that the frequency of content generation within a given location (e.g., event location) exceeds a typical frequency of content generation within a given location as determined from historical content associated with the location (e.g., wherein the typical frequency can be an average frequency, mean frequency, 70 th percentile, etc.).

In one variation, the method includes: determining user attendance at an event by identifying a first electronic message authored by a first user on a social networking service, the first electronic message having associated geographic location information indicative of the event location; identifying a second electronic message authored by the first user within a predetermined time duration from the first electronic message; extracting the geographic location data from the first electronic message; and associating the extracted geographic location data with the second electronic message. The method can be performed upon determination of a disjunction between the location data of the first and second electronic messages. The second electronic message, as authored by the user, can include or lack associated location data. In the former instance, the method adjusts or refines the location data of the second electronic message, wherein the location data of the first electronic message can have higher resolution, be more accurate (e.g., as determined from accuracy metadata sent from the generating user device), or be otherwise different from the location data of the second electronic message. In the latter instance, the method introduces location data to the second electronic message. The second electronic message can be from the same social networking system as the first electronic message, or can be from a separate social networking system. The predetermined time duration is preferably a pre-set duration (e.g., the event timeframe, 20 minutes, 24 hours, etc.), but can alternatively be dynamically selected or determined based on the type of event.

In another variation, the method includes: determining a set of user accounts associated with a first user for each of a set of social networking systems, an event timeframe, and an event location; receiving a set of digital content generated by the user accounts during the event timeframe; associating the event location with a first digital content of the retrieved set of digital content; and in response to receipt of an event query from a device, sending a subset of the digital content set to the device. The set of user accounts, the event timeframe, and the event location can be received from a user, dynamically determined from content generated by secondary users, or otherwise determined. Associating the event location with a first digital content of the retrieved set of digital content is preferably performed in response to determining that the first digital content lacks an geographic location identifier as a content parameter, but can alternatively be performed in response to the first digital content having a geographic location identifier different from the majority of the retrieved digital content set, or performed in response to the satisfaction of any other suitable tagging condition. Alternatively, the digital content can not be associated with the event location when keywords indicative of user absence from the event are detected within the content (e.g., “missing,” “not there,” etc.).

In another variation, the method includes receiving a first digital content and a second digital content from the same social networking system and generated by the same user account within the event timeframe. The geographic location information extracted from the first digital content is used to geotag the second digital content.

In another variation, the method includes receiving a first digital content and a second digital content, generated by the same user within the event timeframe, from a first and a second social networking system, respectively. The geographic location information extracted from the first digital content is used to geotag the second digital content.

In another variation, the method includes receiving a first digital content and a second digital content generated by the same user. The first and second digital content can be from the same social networking system or from different social networking systems. The first digital content has a first timestamp and the second digital content has a second timestamp different from the first digital content. The event parameters are determined from the first digital content, and are used to identify and tag the second digital content. More specifically, the location information extracted from the first digital content is used to geotag the second digital content. Additionally, the first digital content can reference a future timeframe, wherein the second digital content is generated within timeframe (e.g., as determined by the second timestamp). Alternatively, the future timeframe can be determined from a third digital content, wherein the first and third digital content are associated together by keyword. For example, the first digital content can include “going to vacation in Hawaii” and the second digital content can include “vacation in two weeks”. The third digital content can be generated by the first user or generated by a second user, in which case the third digital content preferably additionally includes a reference to a user account of the first user.

In another variation, the method can include receiving a first digital content and a second digital content authored by a first and second user, respectively, wherein the second digital content is associated with an event location (e.g., geotagged) and references the author of (user associated with) the first digital content. The first and second digital content can be from the same social networking system, or be from different social networking systems. The author of first digital content is preferably an influencer, wherein the system is monitoring content generated by secondary users that reference the influencer. However, the author of the first digital content can be any other suitable user. The second digital content preferably has an associated geographic location that is associated with the event location. The second digital content preferably includes a reference to the first user (e.g., link to an account of the first user, name of the first user, etc.). The first digital content can be associated with a geographic location in response to determination of keywords indicative of first user attendance at the event associated with the second digital content or proximity to the second user (e.g., “here,” “next to,” etc.), wherein the geographic location is preferably a location extracted from the second digital content but can be a predetermined event location or any other suitable location.

The above methods are preferably implemented in a computer-readable medium storing computer-readable instructions. The computer-readable medium is preferably a mobile device such as a smartphone, tablet, smartwatch, or laptop, but can alternatively be a server, a desktop computing system, or any other suitable computer-readable medium. The instructions are preferably executed by computer-executable components preferably integrated with a content search system. The communication routing system may include a content search system, a content scraping or monitoring system, and geotagging system. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

1. A method comprising:
at a computing system:
determining a set of user accounts associated with a first user for each of a set of social networking services;
determining an event timeframe for an event;
receiving, at the computing system, a set of digital content comprising digital content generated by the set of user accounts during the event timeframe;
extracting geographic location information from the set of digital content;
in response to the extracted geographic location information indicating a single geographic location beyond a predetermined frequency within a threshold time period, setting the geographic location as an event location for the event;
detecting a first digital content lacking geographic location information within the digital content set;
in response to detection of the first digital content lacking geographic location information within the digital content set, associating the event location with the first digital content;
receiving a query comprising an identifier for the event from a device; and
in response to receipt of a query comprising an identifier for the event from a device, sending the first digital content to the device.

2. The method of claim 1, wherein determining the event location comprises:
monitoring secondary digital content on a set of social networking services;
in response to a volume of secondary digital content having associated location information indicative of a single geographic location exceeding a threshold, setting the geographic location as the event location.

3. The method of claim 1, wherein the event location comprises a geographic location defined by a boundary, wherein determining the event location comprises:
extracting geographic location information from the set of digital content;
in response to the extracted geographic location information indicating a single geographic location beyond a predetermined frequency, setting the geographic location as the event location.

4. The method of claim 1, wherein the event location comprises a geographic location defined by a boundary, the method further comprising:
in response to the extracted geographic information indicating a geographic location beyond the boundary of the event location, extending the boundary of the event location to include the geographic location.

5. The method of claim 1, further comprising:
in response to the extracted geographic location information indicating a geographic location differing from the event location beyond a predetermined frequency, assigning the extracted geographic location identifier as the event location.

6. The method of claim 5, wherein further comprising obfuscating the geographic location information prior to assignment as the event location, comprising:
identifying a region encompassing a geographic location indicated by the geographic location information; and
selecting a second location within the region having an abstraction level lower than the region, such that the second location encompasses a smaller area than the region.

7. The method of claim 6, wherein selecting a second location within the region further comprises selecting an abstraction level of the event location for the second location.

8. The method of claim 6, wherein selecting a second location within the region further comprises selecting an abstraction level for the second location based on a volume of digital content having the abstraction level.

9. The method of claim 1, further comprising: in response to receiving digital content generated by one of the set of user accounts having a geographic location identifier associated with the event location within a predetermined time duration after the event timeframe, extending the event timeframe.

10. The method of claim 9, further comprising categorizing the event and selecting the predetermined time duration based on the event category.

11. The method of claim 1, wherein the first user comprises an influencer.

12. A method comprising:
at a computing system:
identifying a first electronic message generated by a first user on a social networking service, the first electronic message comprising a first timestamp and associated geographic location data indicative of a first geographic location;
identifying a second electronic message generated by the first user, the second electronic message comprising a second timestamp within a threshold time duration from the first timestamp and associated geographic location data indicative of a second geographic location;
extracting the geographic location data of the first electronic message; and
replacing the geographic location of the second electronic message with the first geographic location extracted from the geographic location data of the first electronic message.

13. The method of claim 12, further comprising determining an event based on the first user and the geographic location data, wherein the time duration is selected based on the determined event.

14. The method of claim 12, wherein the second electronic message is stored on a second social networking service separate from the first social networking service, wherein the first user is associated with the first social networking service through a first account and is associated with the second social networking service through a second account.

15. The method of claim 14, wherein identifying the first and second electronic message comprises receiving the first and second electronic message at an aggregation system configured to access the first and second social networking systems through the first and second accounts.

16. The method of claim 12, wherein identifying the first electronic message comprises identifying a first electronic message comprising a reference of a timeframe, wherein the second timestamp is within the timeframe.

17. The method of claim 16, wherein the first electronic message further comprises an event reference, wherein extracting the geographic location data associated with the first electronic message comprises extracting the geographic location associated with the referenced event from a secondary source.

18. The method of claim 17, wherein extracting the geographic location associated with the referenced event from the secondary source comprises extracting the geographic location associated with the referenced event from an event database comprising a set of event references and respective geographic locations.

19. The method of claim 17, wherein extracting the geographic location associated with the referenced event from the secondary source comprises extracting the geographic location associated with the referenced event from a third electronic message generated by a second user.

20. The method of claim 19, wherein the third electronic message comprises a reference of the timeframe, the event reference, and an identifier of the first user.

21. The method of claim 12, further comprising:
monitoring a set of electronic messages on the social networking service, the set of electronic messages comprising the first and second electronic messages; and
in response to a number of electronic messages associated with geographic location data indicative of a first geographic location exceeding a first volume threshold, identifying the second electronic message, extracting the geographic location data from the first electronic message, and associating the second electronic message with the extracted geographic location data.

22. The method of claim 21, further comprising:
in response to a number of electronic messages associated with geographic location data indicative of the first geographic location exceeding a second volume threshold, generating an event identifier associated with the first geographic location; and
tagging the first and second electronic message with the event identifier.

23. The method of claim 12, further comprising: in response to receipt of an event query comprising an event associated with a geographic location associated with the geographic location data, sending the second electronic message to the user device.

24. The method of claim 23, wherein the second electronic message comprises an image.
